(19) United States
(12) Patent Application Publication
(10) Pub. No.: US 2015/0302029 A1
(43) Pub. Date: Oct. 22, 2015

(54) IMAGE PROCESSING APPARATUS, IMAGE PROCESSING METHOD, AND NON-TRANSITORY STORAGE MEDIUM STORING IMAGE PROCESSING PROGRAM

(71) Applicant: OLYMPUS CORPORATION, Tokyo (JP)

(72) Inventor: Naoyuki Miyashita, Tokorozawa-shi (JP)

(73) Assignee: OLYMPUS CORPORATION, Tokyo (JP)

(21) Appl. No.: 14/790,569

(22) Filed: Jul. 2, 2015

Related U.S. Application Data
(63) Continuation of application No. PCT/JP2014/079595, filed on Nov. 7, 2014.

(30) Foreign Application Priority Data
Dec. 27, 2013 (JP) 2013-271763

(51) Int. Cl. G06F 17/30; G06T 7/40; H04N 5/232; G06T 7/00

(52) U.S. Cl. CPC G06F 17/30256; G06T 7/0044; G06T 7/0051; G06T 7/408; G06F 17/30259; G06F 17/3025; G06F 17/30265; G06F 17/30274; H04N 5/23222; H04N 5/23293; G06T 2207/10024; G06T 2207/10004; G06T 2207/20081; G06T 2207/30244

(57) ABSTRACT

An image processing apparatus includes a subject information acquiring unit, a reference image acquiring unit, a photographic process information acquiring unit, and a presenting unit. A subject information acquiring unit acquires subject information from input photographic image data. A reference image acquiring unit acquires a reference image corresponding to the subject information. A photographic process information acquiring unit acquires photographic process information including photographic process images that correspond to the reference image acquired by the reference image acquiring unit and that have been acquired at the time of the photography of the reference image. A presenting unit displays the photographic process information or the reference image.

### CROSS-REFERENCE TO RELATED APPLICATIONS

This application is a Continuation Application of PCT Application No. PCT/JP2014/079595, filed Nov. 7, 2014 and based upon and claiming the benefit of priority from the prior Japanese Patent Application No. 2013-271763, filed Dec. 27, 2013, the entire contents of both of which are incorporated herein by reference.

### BACKGROUND OF THE INVENTION

1. Field of the Invention

The present invention relates to an image processing apparatus, an image processing method, and a non-transitory storage medium storing an image processing program.

2. Description of the Related Art

Various suggestions regarding techniques for presenting assist information to assist in photographic actions have been made. For example, an image photography system for giving guidance on a photographic technique has been suggested in Jpn. Pat. Appln. KOKAI Publication No. 2007-235508. This image photography system presents a sample image (reference image) corresponding to an input keyword to a user together with photographic conditions and the photographic technique. The user sets photographic conditions in accordance with the presented photographic conditions, and performs photography in accordance with the presented photographic technique, and can thereby acquire an image similar to the sample image.

In the suggestion according to Jpn. Pat. Appln. KOKAI Publication No. 2007-235508, when the state of a subject which the user is attempting to photograph is the same as the state of the subject at the time of the photography of the sample image, photography is performed in accordance with the presented photographic conditions and a photographic technique, so that a photograph imaged by the user is taken. However, in actuality, the state of the subject which the user is attempting to photograph is not always the same as the state of the subject in the sample image. When the states of the subject are not the same, it is difficult to take a photograph as imaged even if the photographic conditions are adjusted. Here, if the user knows the photographic process of the sample image, the user may be able to know, from this photographic process, photographic conditions and a photographic technique for taking a photograph having an image similar to that of the sample image.

The present invention has been made in view of the above-mentioned circumstances, and is intended to provide an image processing apparatus, an image processing method, and a non-transitory storage medium storing an image processing program which can present information that permits a photograph imaged by a user to be taken.

### BRIEF SUMMARY OF THE INVENTION

An image processing apparatus according to a first aspect of the invention comprises: a subject information acquiring unit which acquires subject information from input photographic image data; a reference image acquiring unit which acquires a reference image corresponding to the subject information acquired by the subject information acquiring unit; a photographic process information acquiring unit which acquires photographic process information including photographic process images that correspond to the reference image acquired by the reference image acquiring unit and that have been acquired at the time of the photography of the reference image; and a presenting unit which displays the photographic process information or the reference image acquired by the photographic process information acquiring unit.

An image processing method according to a second aspect of the invention comprises: acquiring subject information in input image data; acquiring a reference image corresponding to the subject information; acquiring photographic process information including photographic process images that correspond to the acquired reference image and that have been acquired at the time of the photography of the reference image and operational information corresponding to each of the photographic process images; and displaying the photographic process information or the reference image that has been acquired.

A non-transitory computer-readable storage medium according to a third aspect of the invention, stores an image processing program which allows a computer to: acquire subject information from input image data; acquire a reference image corresponding to the subject information; acquire photographic process information including photographic process images that correspond to the acquired reference image and that have been acquired at the time of the photography of the reference image and operational information corresponding to each of the photographic process images; and display the photographic process information or the reference image that has been acquired.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing a configuration example of an image processing apparatus according to a first embodiment of the present invention;

FIG. 2 is a diagram showing a configuration example of photographic process information;

FIG. 3 is a diagram illustrating the kind of subject;

FIG. 4 is a diagram showing a configuration example of a subject information acquiring unit;

FIG. 5 is a diagram showing an example of the sending and receiving of data between an imaging device and a reference image DB;

FIG. 6 is a diagram showing a selection example of a reference image when multiple reference images are displayed;

FIG. 7 is a diagram showing an example of a time-series moving image display of the photographic process information;

FIG. 8 is a diagram showing a display example in which photographer operation values and camera automatic set values are separated;

FIG. 9 is a diagram showing a photography example according to a presented photographic process;

FIG. 10A is a first diagram showing an example in which the change of the display of a photographic process image and the change of the display of operational information do not synchronize;

FIG. 10B is a second diagram showing an example in which the change of the display of the photographic process image and the change of the display of the operational information do not synchronize;

FIG. 11 is a diagram showing a display example in which the photographer operation values and the camera automatic set values are not separated;

FIG. 12 is a diagram showing a configuration example of an image processing apparatus which further has a presented information processing unit according to a seventh embodiment;

FIG. 13 is a diagram showing a first guide example for a user to reflect the photographer operation value in the imaging device;

FIG. 14 is a diagram showing a second guide example for the user to reflect the photographer operation value in the imaging device;

FIG. 15 is a diagram showing a third guide example for the user to reflect the photographer operation value in the imaging device;

FIG. 16 is a diagram showing a display example in which multiple photographic process images and operational information are displayed side-by-side;

FIG. 17 is a diagram showing a modification in which the reference image and the photographic process information are displayed in an external device; and

FIG. 18 is a diagram showing a configuration example for easily reflecting the photographer operation value in the imaging device.

### DETAILED DESCRIPTION OF THE INVENTION

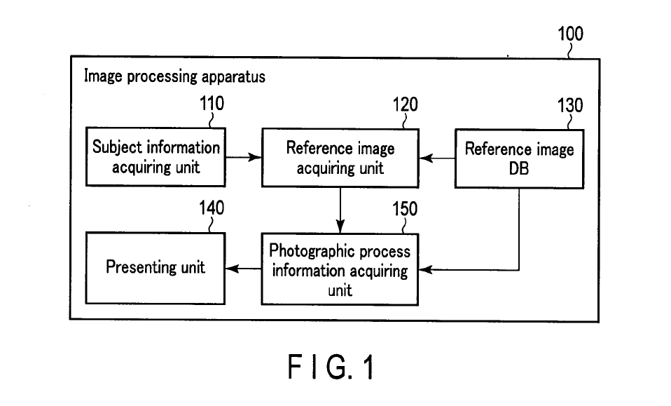

An image processing apparatus according to a first embodiment of the present invention is described below with reference to the drawings. FIG. 1 shows the overview of the configuration of this image processing apparatus. An image processing apparatus 100 in FIG. 1 is mounted on, for example, an imaging device. The explanation is continued below on the assumption that the image processing apparatus 100 is mounted on the imaging device. The image processing apparatus 100 in FIG. 1 includes a subject information acquiring unit 110, a reference image acquiring unit 120, a reference image DB 130, a photographic process information acquiring unit 150, and a presenting unit 140. The subject information acquiring unit 110 acquires subject information regarding a subject in input image data. When the image processing apparatus 100 is an imaging device, the subject information acquiring unit 110 is an imaging unit. The subject information is, for example, a subject kind obtained by image recognition. The reference image acquiring unit 120 searches the reference image DB 130 based on the subject information acquired by the subject information acquiring unit 110 to acquire a reference image regarding the subject which a user is to photograph. The reference image DB 130 is a database which stores the reference image and photographic process information in association with each other. The reference images are images showing creation examples of photographs of various subjects. The photographic process information is information showing photographic processes of the photography of the reference images by the photographer. The photographic process information will be described in detail later. The reference image DB 130 may be separate from the image processing apparatus 100. The photographic process information acquiring unit 150 receives the reference image from the reference image acquiring unit 120, and acquires the photographic process information corresponding to the reference image from the reference image DB 130. The presenting unit 140 presents the reference image or the photographic process information to the user. The subject information acquiring unit 110 may not be an imaging device. For example, the subject information acquiring unit 110 may acquire subject information in image data input from a different device.

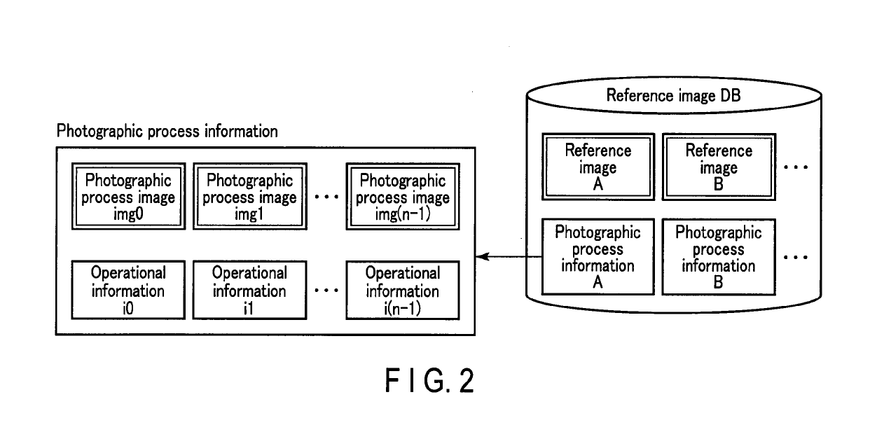

The configuration of the photographic process information is shown in FIG. 2. The photographic process information includes photographic process images and operational information. The photographic process images are n images acquired in a time-series manner in the process of the photography of the reference image. Photographic process images img0 to img(n−1) are acquired, for example, when an operation is performed on the image processing apparatus 100 by the photographer of the reference image. Operational information i0 to i(n−1) are associated with the photographic process images img0 to img(n−1), and are information indicating photographic conditions at the time of the photography of the photographic process images, respectively. The photographic conditions are, for example, a photography mode at the time of the acquisition of the photographic process image, image processing setting, a kind of lens, a focal distance, an aperture value and a shutter speed as parameters for determining exposure, sensitivity, and whether the composition is changed. The reference image is taken by the photographer of the reference image after multiple photographic processes. The user can see the photographic process information and thereby easily know the process of taking images such as the reference image.

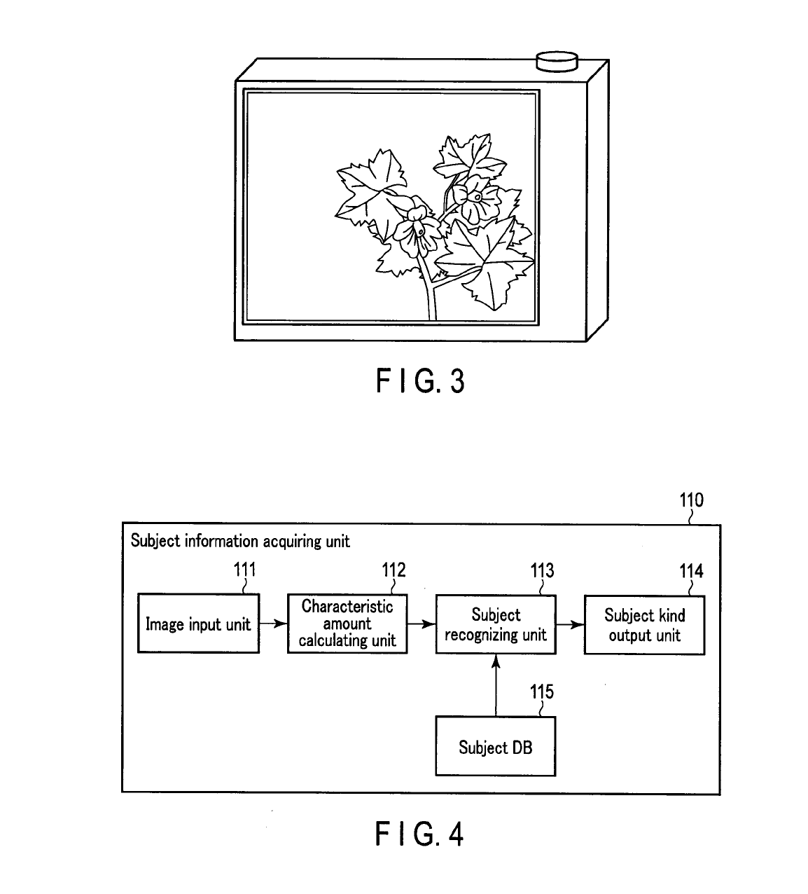

The operation of the imaging device according to the first embodiment is described below. From now on, the explanation is given on the assumption that the subject is a white flower. Meanwhile, when the white flower is displayed in a through-image as shown in FIG. 3, the subject information acquiring unit 110 identifies the subject information. The subject information is, for example, a subject kind, and is, for example, a “flower” or a “white flower”. Alternatively, when the entire atmosphere including the white flower and the background of this flower can be represented by a sensitivity word such as “bright”, the “bright” may be the later-described scene kind of the image data.

First, a subject kind as an example of the subject information in the subject information acquiring unit 110 is acquired. A configuration example of the subject information acquiring unit 110 is shown in FIG. 4. The subject information acquiring unit 110 includes an image input unit 111, a characteristic amount calculating unit 112, a subject recognizing unit 113, a subject DB 115, and a subject kind output unit 114. The image input unit 111 receives light emitted from the subject in an unshown light receiving surface, and converts the light to an electric signal (image data). When the image processing apparatus 100 is not an imaging device, the image input unit 111 acquires the image data from a different device. The characteristic amount calculating unit 112 calculates an image characteristic amount of, for example, a shape or a color in the image data. The image characteristic amount of the shape is calculated by, for example, SIFT or HOG. The image characteristic amount of the color may be calculated on the basis of an RGB histogram or an HSV histogram. The subject database (DB) 115 stores the image characteristic amount and the subject kind in association with each other. The subject image DB 150 may be separate from the subject information acquiring unit 110. The subject recognizing unit 113 uses mechanical learning based on SVM to identify a subject kind by referring to the characteristic amount calculated by the characteristic amount calculating unit 112 and the image characteristic amount stored in the subject recognizing unit 113. The subject kind output unit 114 outputs information regarding the subject kind identified by the subject recognizing unit 113 to the reference image acquiring unit 120. When the subject is a white flower, the information regarding the subject kind may be, for example, text data “flower” or a unique ID corresponding to the kind “flower”. Hereinafter, the output information regarding the subject kind is text data.

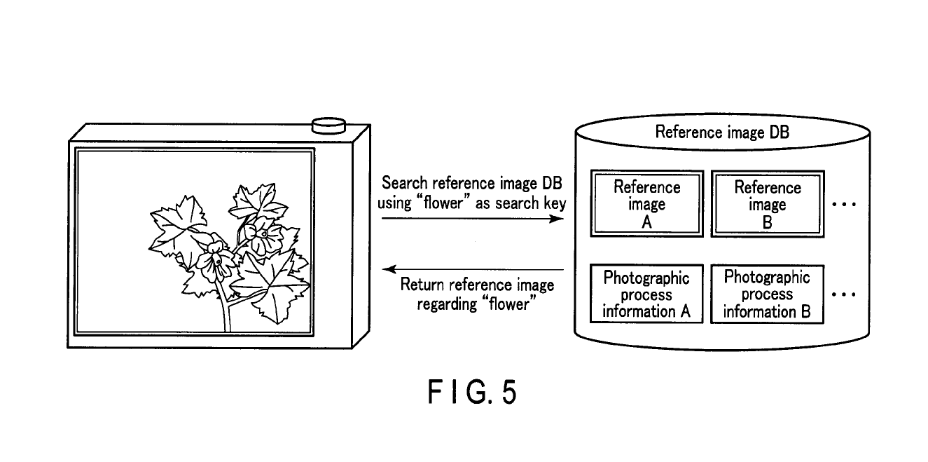

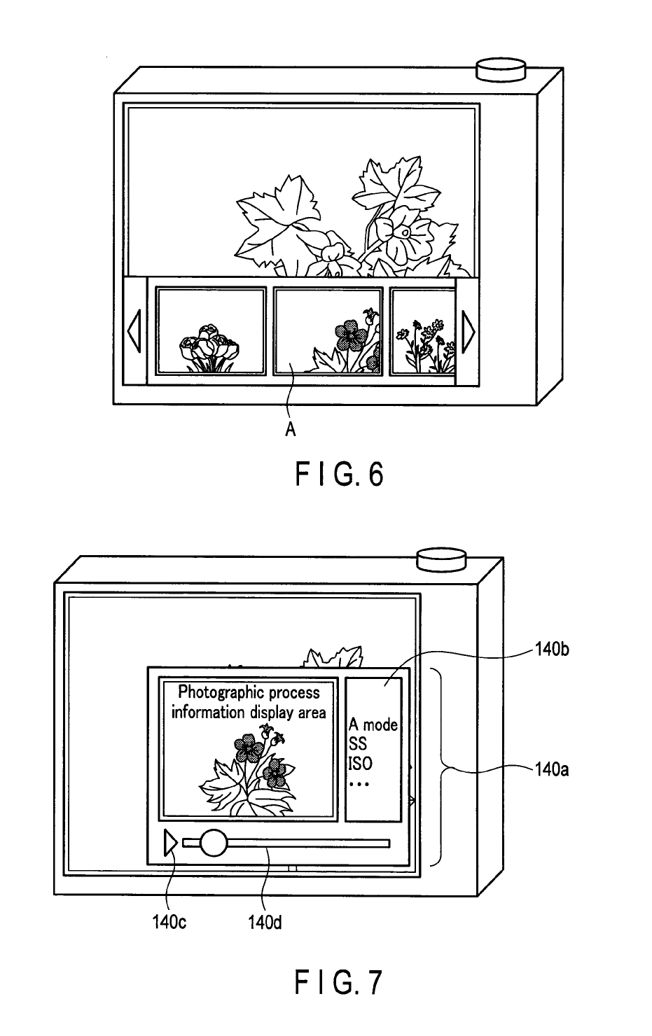

An acquisition example of the reference image is shown in FIG. 5. If a subject kind as an example of the subject information is acquired in the subject information acquiring unit 110, a reference image regarding the “flower” is acquired from the reference image DB 130 by the reference image acquiring unit 120 using the text data “flower” regarding the subject kind as a search key. If the reference image is acquired, the acquired reference image is presented to the user by the presenting unit 140. For example, FIG. 6 shows an example in which multiple reference images are presented. When multiple reference images are presented, the user selects, from among the presented reference images, a reference image close to the photograph which the user is to take. For example, suppose that a reference image A in FIG. 6 is selected. In this instance, photographic process information corresponding to the reference image A is acquired from the reference image DB 130 by the photographic process information acquiring unit 150. The acquired photographic process information is presented to the user from the presenting unit 140.

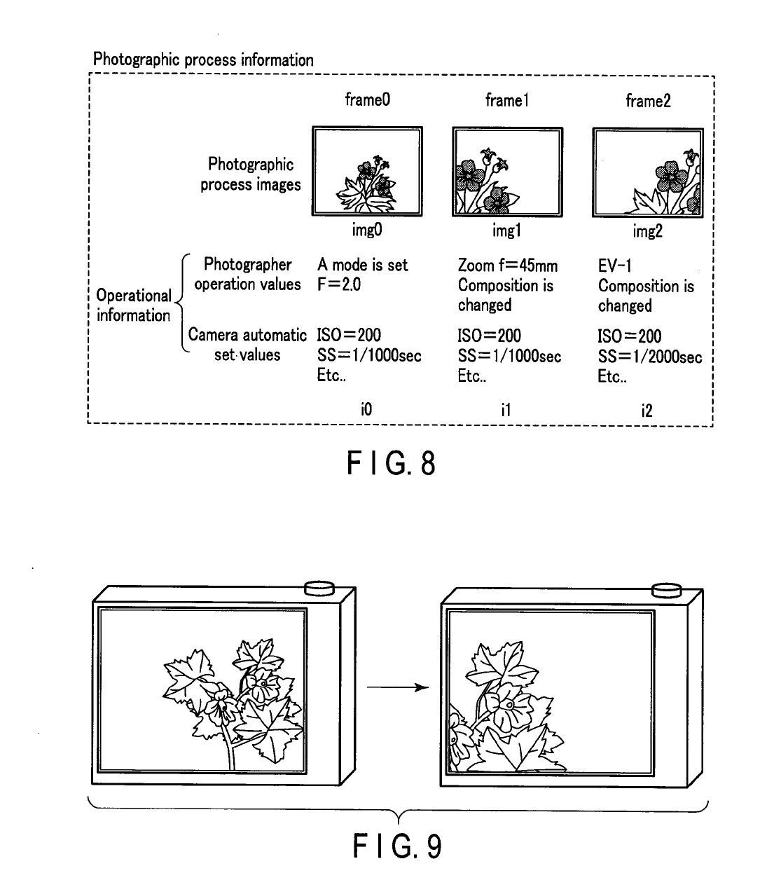

As an example of presenting the operation state of the photographic process information to the user, one photographic process image and operational information corresponding to this photographic process image may be displayed in a time-series order as shown in FIG. 7. A photographic process information display area representing an area where the photographic process information is displayed is shown in FIG. 7. The photographic process information display area includes a photographic process image display area 140a to display the photographic process image, an operational information display area 140b to display the operational information, a reproduction button 140c, and a seek bar 140d. If the reproduction button 140c is selected, a photographic process image and operational information corresponding to this photographic process image are displayed in a time-series manner: frame 0, frame 1, frame 2 . . . , as shown in FIG. 8. The position on the seek bar 140d corresponds to the order of the time-series photographic process images and operational information. If the user touches the seek bar 140d, the photographic process image corresponding to the touched position and the operational information corresponding to this photographic process image are displayed. In the display in the operational information display area 140b, a photographer operation value and a camera automatic set value that will be described later are separately displayed as operational information.

The photographer operation value and the camera automatic set value are described with reference to FIG. 8. The photographer operation value is a photographic condition determined by the operation performed by the photographer who has taken the photographic process image. In contrast, the camera automatic set value is a photographic condition automatically determined by the photographer operation value. A unique photographic condition of the imaging device which has taken the reference image may be further added to the operational information. The user can easily trace the photographic condition in the photographic process by knowing the photographer operation value of the photographic process image. When the photographic process image and the operational information are presented at the same time, the image processing apparatus 100 easily allows the user to know the correspondence between the photographic process image and the photographic condition.

Each photographic condition can be allocated to any of the photographer operation value and the camera automatic set value. For example, in the first embodiment, if an aperture value is determined, another photographic condition is determined, and in a photography mode in which exposure is determined by the determination of the other photographic condition, that is, in an A-mode (aperture priority automatic mode), the photographic conditions classified into the photographer operation value are an aperture value and a focal distance. The camera automatic set values in the A-mode are, for example, ISO sensitivity and a shutter speed (SS). In contrast, in a mode other than the A-mode, for example, a manual mode (M-mode) in which the user determines many photographic conditions, most of the photographic conditions are classified into the photographer operation values.

A photography example in which the user acquires a photographic technique by the image processing apparatus 100 is shown in FIG. 9. The subject is a white flower shown in FIG. 9. Meanwhile, suppose that a reference image and photographic process information regarding a pink flower shown in FIG. 8 are acquired by the image processing apparatus 100. Here, suppose that the user has photographed the white flower while seeing the photographic process image and the operational information. In this case, if EV-1 of the photographer operation value at the time of the photography of the pink flower is applied to the photography of the white flower, the white color of the white flower may be dark. In this instance, the user is looking at the photographic process image, and can therefore know that the image has darkened by the application of EV-1 of the photographer operation value. Therefore, there is a possibility that the user can notice the intention of the photographer of the reference image to set to EV-1 to emphasize the color of the flower because the flower is pink. In this case, for example, the user can choose to make no exposure correction if the flower is a white flower, and perform photography by referring to other photographer operation values. In this way, the user can acquire an image as imaged.

As described above, the reference image which is a photography example of the subject and the photographic process information for guiding the photographic process to perform photography as in the reference image are presented to the user by the image processing apparatus 100 according to the first embodiment of the present invention. The photographic process information includes multiple photographic process images acquired in the process of taking the reference image, and operational information which are associated with each of the photographic process images and which shows the photographic conditions of the photographic process images. Such photographic process information is presented to the user, so that the user can more easily photograph an image as imaged. Further, the operational information is classified into the photographer operation value which is a photographic condition set by the photographer at the time of the acquisition of the photographic process image, and the camera automatic set value which is a photographic condition automatically set in the imaging device. The photographer operation value and the camera automatic set value are separately presented, so that the user can know the intention of the photographer of the reference image by comparing the photographic process image with the operational information, and more easily photograph an image as imaged.

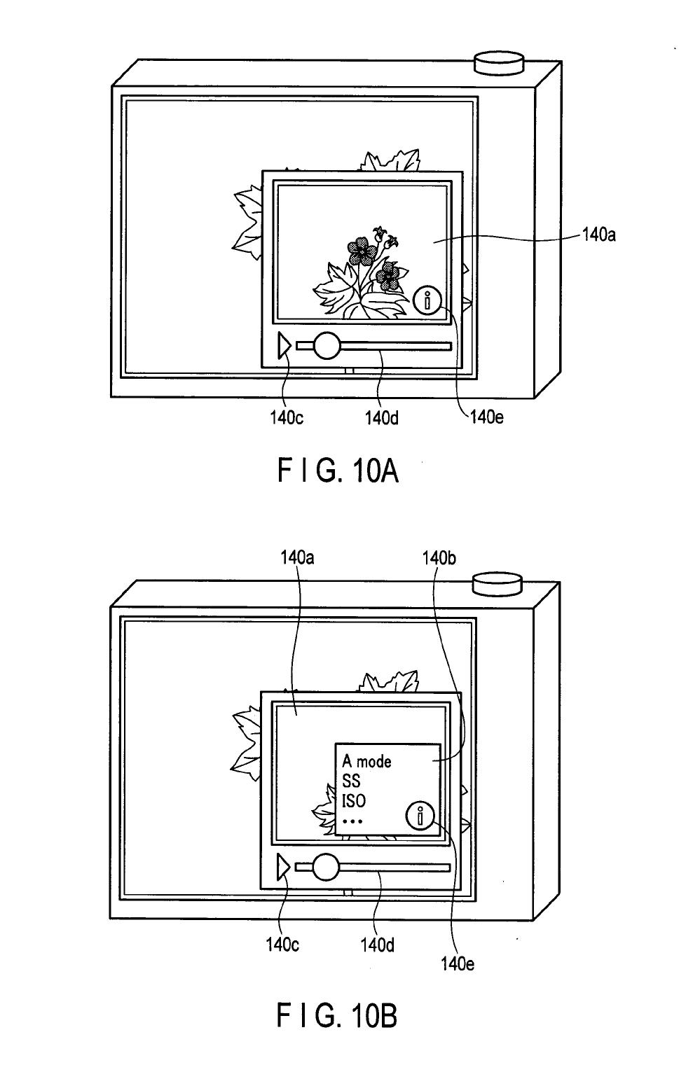

Next, a second embodiment is described with reference to FIG. 10A to FIG. 10B. In the second embodiment, an operational information display button 140e to switch on and off the display of the operational information display area 140b is newly displayed in the photographic process information display area. When the display of the operational information is set to be off, the photographic process image display area 140a, the seek bar 140d, the reproduction button 140c, and the operational information display button 140e are displayed in the photographic process image display area 140a of the presenting unit 140 as shown in FIG. 10A. First, the presenting unit 140 displays a photographic process image in a photographic process image area. In this instance, if the seek bar 140d is operated, the presenting unit 140 displays a next photographic process image. If the operational information display button 140e is selected so that the operational information is set to be displayed, the presenting unit 140 then displays the operational information in the operational information display area 140b as shown in FIG. 10B. In this instance, if the seek bar 140d is operated, the next photographic process image and the operational information corresponding to this photographic process image are displayed. In this instance, the user can easily read the change of the operational information relative to the change of the photographic process image. In contrast, if the operational information is not displayed constantly, the display of the photographic process is not blocked by the display of the operational information.

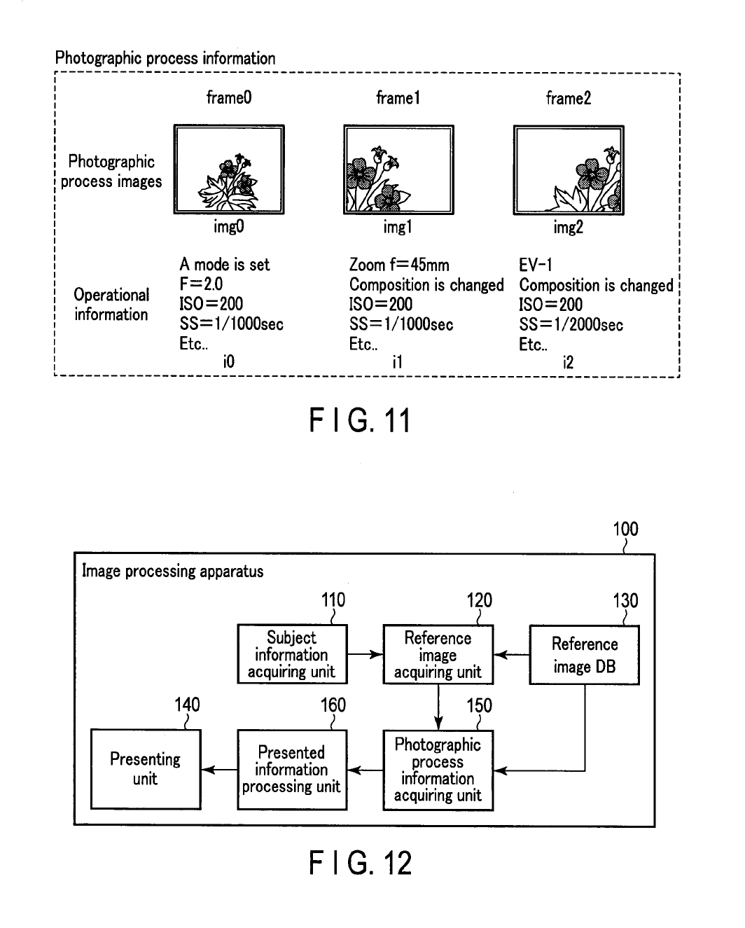

Next, a third embodiment is described with reference to FIG. 11. FIG. 11 is a diagram showing a modification of the display method of the operational information. In the third embodiment, the photographer operation values and the camera automatic set values are inseparately displayed. The operational information may also be displayed in this way.

Next, a fourth embodiment is described. In the example described above, the photographic process image is acquired when an operation to change the photographic condition is performed by the photographer. In contrast, the photographic process image according to the fourth embodiment is image data acquired by the photographer of the reference image performing a release operation. That is, an image for which the release operation has been performed is only presented to the user as a photographic process image, so that the user can acquire photographic know-how for photographing the subject more than one time to the finish.

Next, a fifth embodiment of the present invention is described. In the fifth embodiment, the later-described scene kind is used as subject information. The configuration of the image processing apparatus 100 and the presentation to the presenting unit 140 are the same as those in the first embodiment, and explanations of these are omitted.

In the fifth embodiment, the reference image and the photographic process information are not only associated with the subject kind but also associated with the scene kind. The scene kind is the kind of scene which the user is to photograph. Here, in the fifth embodiment, the impression of a photograph that does not apply to the subject kind is referred to as a scene. The scene kind is defined by, for example, a sensitivity word or an impression word. The sensitivity word is, for example, warm, cold, neat, or pretty. The impression word is, for example, bright, dark, red, or blue. The scene kind is identified, for example, from the image characteristic amount. Thus, the reference image and the photographic process information corresponding to the scene kind are acquired. It goes without saying that not only the image data acquired by the image processing apparatus 100 but also externally acquired image data can be classified in terms of scene kind.

In the fifth embodiment, by using both the identification of the subject kind and the identification of the scene kind, it is possible to reduce the situations in which identification is based solely on the subject kind.

Next, a sixth embodiment of the present invention is described without drawings. In the sixth embodiment, positional information and azimuthal information are presented to the user. The description of the configuration of the image processing apparatus 100 according to the sixth embodiment that is similar to the configuration according to the first embodiment is omitted.

The image processing apparatus 100 according to the sixth embodiment further includes a position sensor such as a GPS which detects latitudinal information and longitudinal information regarding the image processing apparatus 100, and an azimuth sensor such as an electronic compass which detects the direction of the image processing apparatus 100 from terrestrial magnetism.

In the photographic process information according to the sixth embodiment, latitudinal information, longitudinal information, and directional information regarding each photographic process image at the time of photography are stored in addition to the photographic process image and the operational information described in the first embodiment.

The subject recognizing unit 113 according to the sixth embodiment not only identifies the subject kind by the image characteristic but also identifies the subject kind by referring to the positional information or the azimuthal information regarding the image processing apparatus 100 and the positional information or the azimuthal information regarding each piece of photographic process information stored in the subject DB 115. The subject kind is more accurately identified by the use of both the identification of the subject kind by the image characteristic amount in the first embodiment and the identification of the subject kind by the positional information or the azimuthal information. Alternatively, the subject information may be the positional information or the azimuthal information. The reference image DB 130 further has a reference image, and positional information associated with the reference image. The reference image acquiring unit may search the reference image DB 130 on the basis of the positional information or the azimuthal information regarding the subject to acquire the reference image regarding the subject which the user is to photograph. When image data is externally acquired, the image processing apparatus 100 may identify the subject by referring to positional information included in the image data if the positional information is included in the image data.

Although the image processing apparatus 100 acquires the positional information by using the internal position sensor, the image processing apparatus 100 may acquire the positional information from an external device. In the sixth embodiment, the presenting unit 140 may present, to the user, the positional information stored in the photographic process information, and the positional information and the azimuthal information regarding the image processing apparatus 100 detected by the GPS and the electronic compass. The user can thus easily know the position and direction to photograph from the reference image.

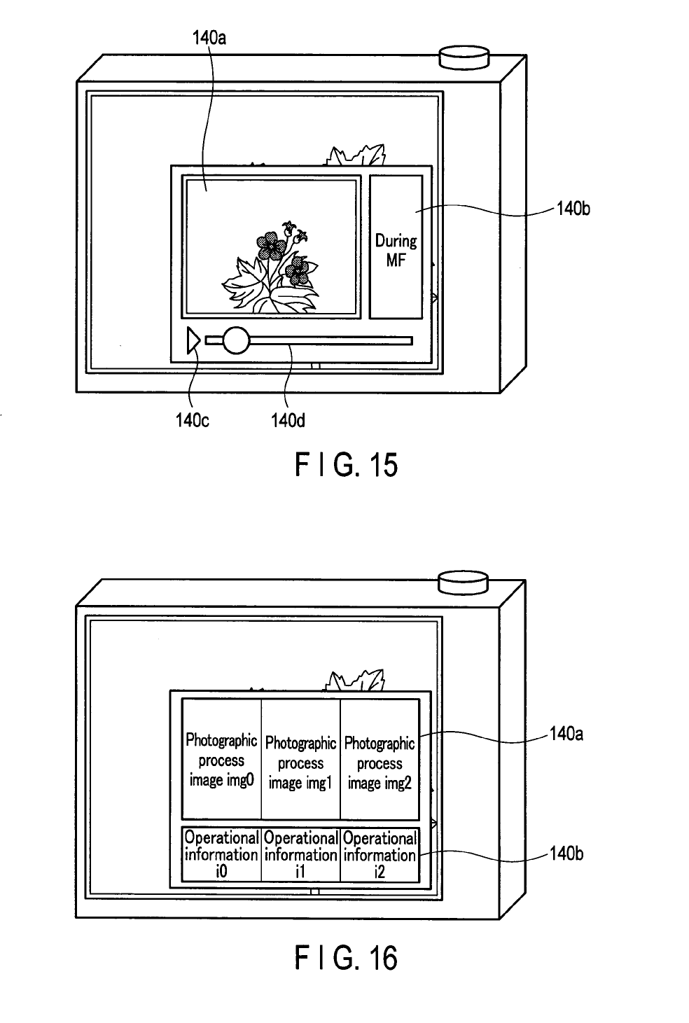

A seventh embodiment of the present invention is described with reference to FIG. 12 and FIG. 15. The seventh embodiment shows first to third guide examples for the user to reflect the photographer operation value in the imaging device.

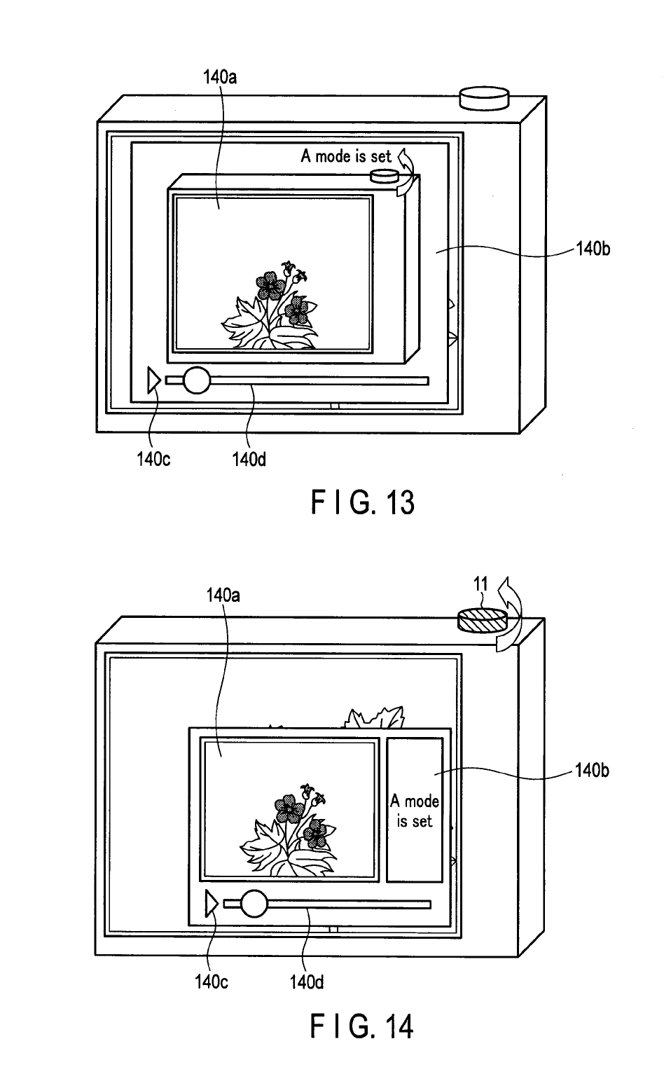

In the first guide example, the presenting unit 140 displays an imaging device image that shows an operational component for changing the photographer operation values, together with the photographic process image and the operational information. The imaging device image may be an image that shows the image processing apparatus 100 as the imaging device, or may be an image of the imaging device different from the image processing apparatus 100. A modification of the configuration of the image processing apparatus 100 in the first guide example is shown in FIG. 12. The image processing apparatus 100 in the first guide example further includes a presented information processing unit 160. The presented information processing unit 160 detects the change of the operational information sequentially read by the photographic process information acquiring unit 150. When detecting the change of the photographic process information, the presented information processing unit 160 highlights the image showing the operational component. The first guide example is also shown in FIG. 13. For example, suppose that the operational information changes to a different value, for example, the M-mode changes to the A-mode during the reproduction of the photographic process image. In this instance, the imaging device image for changing the photography mode is highlighted; for example, an image of an arrow is displayed over the imaging device image. Owing to the presentation of the image of the arrow, the user can visually learn about the operational component for the operation of changing the photography mode and how to use the operational component, and can therefore more easily acquire a photographic technique.

Next, the second guide example is shown in FIG. 14. In the second guide example, an LED light 11 is disposed to be buried in the transmitting operational component adapted to the operation of photographer information in the image processing apparatus 100 as shown in FIG. 14. When the operational information changes to a different value during the reproduction of the photographic process image, the LED light 11 in the operational component for changing the operational information flashes, for example. The operational component to be operated is indicated to the user by the flashing of the LED light 11. In the second guide example, part of the display of the presenting unit 140 is not occupied by the imaging device image in contrast with the first guide example, so that other images can be displayed larger than in the first guide example.

The third guide example is shown in FIG. 15. In the third guide example, the presenting unit 140 displays, for example, information “during MF” in the operational information display area 140b when an operation that is changed with a time width such as manual focus is performed. The user can more easily know the intention of the photographer of the reference image than when the operational information regarding the operation with the time width is shown as it is.

Next, an eighth embodiment of the present invention is described. In the eighth embodiment, a given photographic process image is selected and displayed from among multiple photographic process images in the photographic process information.

The photographic process information in the eighth embodiment includes photographic process images taken and acquired at a predetermined frame rate (e.g. 60 fps), and operational information corresponding to each of the photographic process images. When the photographic process images which have been acquired at 60 fps and which are adjacent in a time series recorded in the operational information are read and presented, the user frequently recognizes the change of the operational information, and may therefore be bothered by the recognition of the multiple photographic process images. Thus, to only present photographic process information necessary for taking a photograph imaged by the user from among the images acquired at 60 fps, the photographic process information acquiring unit 150 selects some of all the photographic process information. The photographic process information acquiring unit 150 acquires the photographic process images selected at regular intervals in a time series from the photographic process images saved in the reference image DB 130. Alternatively, the presented information processing unit 160 described in the seventh embodiment may be used to select the photographic process images at regular intervals in a time series from among the photographic process images included in the photographic process information acquired by the photographic process information acquiring unit 150. Alternatively, whether the changes of the photographic process images (e.g., the change of brightness, the change of the color, and the change of the composition) are greater than a predetermined threshold is determined by the presented information processing unit 160 regarding the photographic images acquired by the photographic process information acquiring unit 150, and a photographic process image having a value higher than the threshold is selected. In this case, a photographic process image in which the photographer operation value has changed more than a predetermined threshold may be only selected. Alternatively, when the image characteristic amount of the photographic process image has changed more than a predetermined threshold, the presented information processing unit 160 selects a later photographic process image in a time series.

As described above, a photographic process image to be presented is selected from among multiple photographic process images stored in the photographic process information, so that the user need only know the photographic process image necessary for taking a photograph imaged by the user.

A ninth embodiment of the present invention is described with reference to FIG. 16. In the ninth embodiment, the photographic process information acquiring unit 150 selects multiple photographic process images. For example, the photographic process image img0-2, and multiple pieces of photographic process information, i.e., operational information i0-i2 corresponding to each photographic process image are displayed at a time, so that the user can know the changes of the photographic process images adjacent in a time series at a glance. Therefore, it is possible to more easily acquire photographic know-how for the reference image.

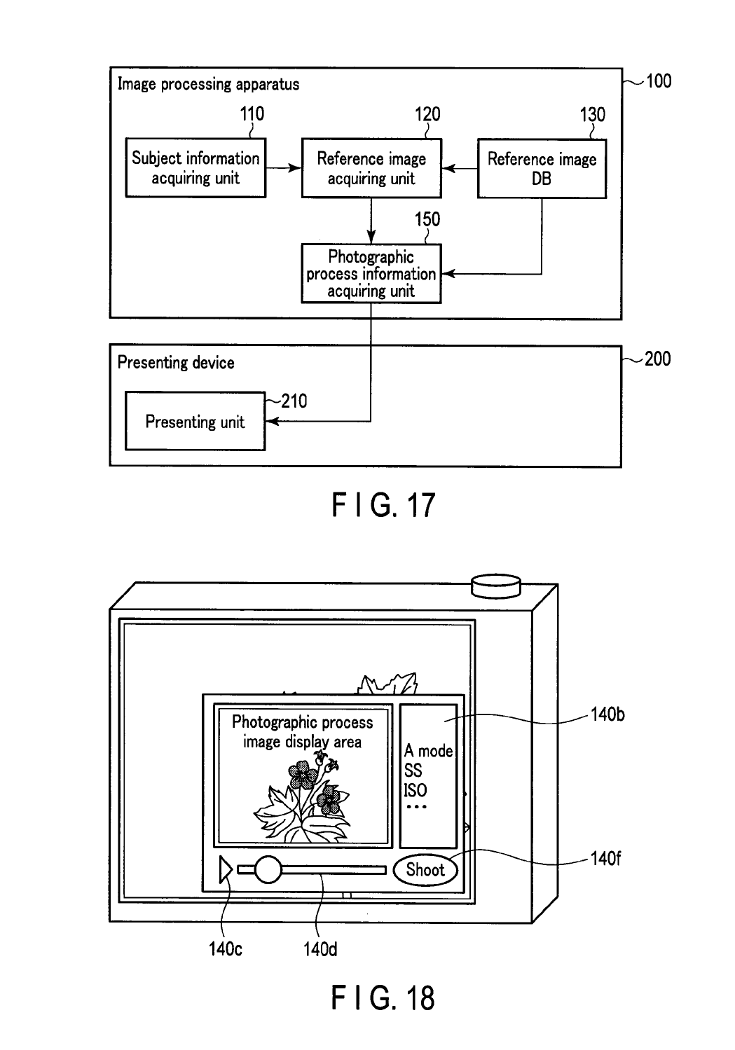

Next, a tenth embodiment of the present invention is described with reference to FIG. 17. In the tenth embodiment, the photographic process information acquiring unit 150 outputs the reference image and the photographic process information to the external device.

In the tenth embodiment, a presenting device 200 which is present outside the image processing apparatus 100 is further provided as shown in FIG. 17. The presenting device 200 is, for example, a tablet terminal or a portable terminal, and includes a presenting unit 210 for presenting images and information. The reference image and the photographic process information input from the photographic process information acquiring unit 150 of the image processing apparatus 100 are sent to the presenting device 200 from the image processing apparatus 100 in a wireless or wired manner. The presenting unit 210 of the presenting device 200 which has received the reference image and the photographic process information displays the reference image and the photographic process information.

As described above, the reference image or the photographic process information is output to the presenting device 200 outside the image processing apparatus 100, so that the reference image or the photographic process information is displayed in the presenting unit 210. In the first embodiment, the reference image or the photographic process information is displayed in the presenting unit 140. In this instance, other images or information such as through-images may be displayed in the presenting unit 140, so that many images or pieces of information may be displayed in an overlapping state. Therefore, it is difficult for the user to have a look at the images or information. Thus, the reference image and the photographic process information are displayed in the presenting unit 210, so that images such as through-images and information can be displayed in the presenting unit 140 without overlapping.

Next, an eleventh embodiment of the present invention is described with reference to FIG. 18. In the eleventh embodiment, the presenting unit 140 displays an operation shift button 140e for reflecting the photographic conditions of the photographic process images at a time. By the selection of the operation shift button 140e, each set value corresponding to the operational information displayed in the photographic process information area is set in the image processing apparatus 100. The photographic conditions may be set by the depression of a mechanical button. The user can immediately start photography corresponding to the photographic conditions of the photographic process image by the operation shift button 140e. The operation shift button 140e can reflect, in the image processing apparatus 100 by one operation, each set value of the operational information corresponding to the photographic process image desired by the user among a series of photographic process images. When the image processing apparatus 100 is connected in such a manner as to be able to communicate with the external imaging device, the image processing apparatus 100 can reflect the photographic conditions in this external imaging device.

Next, a twelfth embodiment of the present invention is described. In the twelfth embodiment, the change of the photographic process image whose display has been switched in the photographic process image display area 140a is highlighted.

The image processing apparatus 100 in the twelfth embodiment has the presented information processing unit 160 described in the seventh embodiment, and has a configuration shown in FIG. 11. The presented information processing unit 160 calculates the image characteristic amounts of two photographic process images that are precedently and subsequently displayed. The changes of the photographic process images are detected by comparing a change amount between the calculated image characteristic amounts with a predetermined threshold. When it is determined as a result of the comparison that there is a difference equal to or more than a predetermined threshold between the image characteristic amounts, an image part having an image characteristic amount indicating the difference equal to or more than the predetermined threshold is highlighted in the presenting unit 140. The highlighting may be, for example, enlarged display or highlighted display of the changed part of the photographic process image. This change may be displayed in the photographic process information display area as character information.

Alternatively, information indicating the changes of multiple photographic process images may be previously added to the photographic process information and saved in the reference image DB. The highlighting in the presenting unit 140 is performed on the basis of the information indicating the changes of the multiple photographic process images.

As described above, in the twelfth embodiment, the changes of the precedently and subsequently displayed photographic process images are highlighted. It may be difficult for the user to recognize the changes in multiple images, such as slight movements of the subject in the photographic process images or slight changes in colors, even by comparing these changes. The changes in the photographic process images are presented to the user so that the user can know a photographic technique for more easily acquiring image data as imaged.

When the image processing apparatus 100 is connected in communication with the external imaging device, the image processing apparatus 100 can perform highlighting based on the operational information in this external imaging device. While the present invention has been described in connection with the first to twelfth embodiments of the present invention, it should be understood that modifications and applications can be made within the scope of the present invention. For example, a schematic diagram shown in FIG. 13 in the seventh embodiment may be displayed in the presenting device 200 described in the tenth embodiment.

Moreover, all the processing by the imaging device according to the embodiments described above may be stored as an executable program. This program can be stored in and read from a storage medium of an external storage device such as a memory card (e.g., ROM card or RAM card), a magnetic disk (floppy (registered trademark) disk or hard disk), an optical disk (CD-ROM or DVD), or a semiconductor memory, and the operation can be controlled by the read program, so that the processing described above can be performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a subject information acquiring unit which acquires subject information from input photographic image data;
a reference image acquiring unit which acquires a reference image corresponding to the subject information acquired by the subject information acquiring unit;
a photographic process information acquiring unit which acquires photographic process information including photographic process images that correspond to the reference image acquired by the reference image acquiring unit and that have been acquired at the time of the photography of the reference image; and
a presenting unit which displays the photographic process information or the reference image acquired by the photographic process information acquiring unit.

2. The image processing apparatus according to claim 1, wherein the photographic process information includes operational information at the time of the photography of the photographic process images.

3. The image processing apparatus according to claim 2, reflecting setting based on the operational information in an imaging device which photographs a subject.

4. The image processing apparatus according to claim 2, wherein the operational information includes a photographer operation value set by an operation, and a camera automatic set value determined when the photographer operation value is set,
the image processing apparatus separately displaying the photographer operation value and the camera automatic set value.

5. The image processing apparatus according to claim 4, further comprising a presented information processing unit which compares photographer operation values that are included in the operational information and that are precedent and subsequent in a time series,
the presented information processing unit further displaying, in an imaging device which photographs a subject, an imaging device image showing the imaging device to set the photographer operation values,
wherein when the presented information processing unit compares the photographer operation values that are included in the operational information and that are precedent and subsequent in the time series and then determines that the photographer operation values have changed,
the presented information processing unit highlights a part of an operational component in which the photographer operation value in the imaging device image has changed.

6. The image processing apparatus according to claim 2, further comprising a presented information processing unit which compares photographer operation values that are included in the operational information and that are precedent and subsequent in a time series,
the presented information processing unit highlights changed parts of the photographic process images.

7. The image processing apparatus according to claim 2, displaying the photographic process images and the operational information in the presenting unit side-by-side.

8. The image processing apparatus according to claim 2, further comprising a presented information processing unit which processes operational information to be displayed in the presenting unit,
wherein when the operational information has a value more than a predetermined threshold, the presented information processing unit highlights the operational information or the photographic process image corresponding to this operational information in the presenting unit.

9. The image processing apparatus according to claim 1, further comprising a position sensor which detects positional information,
wherein the subject information acquiring unit acquires subject information from the positional information detected by the position sensor.

10. The image processing apparatus according to claim 9, wherein the positional information comprises latitudinal information and longitudinal information at the time of the acquisition of each of the photographic process images.

11. The image processing apparatus according to claim 2, wherein the operational information is information indicating at least one of a photography mode at the time of the acquisition of the photographic process image, image processing setting, a kind of lens, a focal distance, an aperture value, a shutter speed, and sensitivity.

12. The image processing apparatus according to claim 1, wherein the subject information acquiring unit acquires the subject information regarding a subject kind.

13. The image processing apparatus according to claim 12, wherein the subject information acquiring unit acquires the subject kind of a scene kind from the photographic image data.

14. The image processing apparatus according to claim 1, wherein the reference image acquiring unit acquires the reference image in accordance with positional information.

15. An image processing method comprising:
acquiring subject information in input image data;
acquiring a reference image corresponding to the subject information;
acquiring photographic process information including photographic process images that correspond to the acquired reference image and that have been acquired at the time of the photography of the reference image and operational information corresponding to each of the photographic process images; and
displaying the photographic process information or the reference image that has been acquired.

16. A non-transitory computer-readable storage medium storing an image processing program which allows a computer to:
acquire subject information from input image data;
acquire a reference image corresponding to the subject information;
acquire photographic process information including photographic process images that correspond to the acquired reference image and that have been acquired at the time of the photography of the reference image and operational information corresponding to each of the photographic process images; and
display the photographic process information or the reference image that has been acquired.
